(19) United States
(12) Patent Application Publication
(10) Pub. No.: US 2013/0075579 A1
(43) Pub. Date: Mar. 28, 2013

(54) ELECTROMAGNETIC WAVE SENSING APPARATUS WITH INTEGRATION OF MULTIPLE SENSORS AND METHOD THEREOF

(71) Applicant: Lite-On Semiconductor Corp., Taipei Hsien (TW)

(72) Inventor: MENG-KUN CHEN, FONGSHAN CITY (TW)

(73) Assignee: LITE-ON SEMICONDUCTOR CORP., TAIPEI HSIEN (TW)

(21) Appl. No.: 13/684,370

(22) Filed: Nov. 23, 2012

Related U.S. Application Data
(63) Continuation-in-part of application No. 12/073,719, filed on Mar. 10, 2008, now abandoned.

(51) Int. Cl. G01J 1/42

(52) U.S. Cl. CPC G01J 1/4204
USPC 250/205; 250/208.2

(57) ABSTRACT

Disclosure is related to an electromagnetic wave sensing apparatus with integration of multiple sensors, and a method for applying the apparatus. According to one of the embodiments, the method adapted to an electronic wave sensing apparatus includes an initialized step of a host enabled to configure one or more sensors of the electronic wave sensing apparatus. The initialization for those sensors includes one or more setting items selected from resolution, gain, data rate, frequency, and driving current. A next step is to set up a control unit electrically connected with the multiple sensors, and the related setting items are such as output format, output gain, output source, output level, and output driving current. Based on the setting items, the signals will be shaped accordingly and be output. In response to the setting items, the control unit drives one or more internal devices or external devices to function the various applications.

### CROSS-REFERENCE TO RELATED APPLICATIONS

This Application is a Continuation-in-Part of application Ser. No. 12/683,682, filed on 7 Jan. 2010, which is a Continuation-in-Part of application Ser. No. 12/073,719, filed on 10 Mar. 2008, and entitled ELECTROMAGNETIC WAVE SENSING APPARATUS.

### BACKGROUND OF THE INVENTION

1. Field of the Invention

The present invention relates to an electromagnetic wave sensing apparatus with integration of multiple sensors and a method thereof; in particular, to an electromagnetic wave sensing apparatus with at least two sensing units respectively used to sense ambient light and electromagnetic wave of specific wavelength range, so as to render various functions.

2. Description of Related Art

The electromagnetic sensing devices in prior art, such as photo sensing device, employ photo-electric effect, in which the sensing unit, e.g. photo diode, may convert the received light energy into electrical signals, also known as photo-electric current.

The photo sensing device can be widely applied to ambient light sensing. The sensing circuit for ambient light is commonly used in the back-light panel in Liquid Crystal Displayers (LCD) screen, whose main purpose is that, as looking at the contents displayed on the screen, the brightness of ambient light may affect the displayed effect; through the feature of ambient light sensing provided by such a sensing circuit, it is possible to cause the back-light module in the screen of the displayer to generate a display effect that the brightness changes but comparatively the brightness of the back-light is not affected. For example, at the outdoor with brighter ambient light, the display screen on a mobile phone can generate back-light with higher brightness, allowing a user to he able to clearly see the contents shown thereon; contrarily, when being indoor with dimmer ambient light, back-light may generate lower brightness so as to save energy.

Related technology, such as the US patent application with publication number 2005/0219228 issued on Oct. 6, 2005, describes a sensing device installed in a mobile device, therein a plurality of sensors are disclosed, as shown in FIG. 1, in which the sensing device 10 includes a plurality of sensors, such as photo sensor 11 and proximity sensor 12. The photo sensor 11 is used to detect the intensity of ambient light, and the proximity sensor 12 is used to detect approaching object and motion thereof. In this application, the sensing device 10 needs to use an integrated circuit 13 to integrate the signals and features of each sensing unit, and provides a user interface not shown), enabling other hosts to set different sensing functions. However, each of different sensors has respectively its different interface and control environment.

Furthermore, the US patent application with publication number 2007/0085157 issued on Apr. 19, 2007 describes an integrated sensor, as shown in FIG. 2, which includes an integrated sensing device 20 directed to ambient light and moving objects sensing. The sensing device has both an emitter 21 and a detector 22 for electromagnetic detection.

The sensing device 20 provides a feature of ambient light sensing, which is further coupled to a microcontroller 23 in a host. The microcontroller 23 is used to switch the modes of the sensing device 20, including a mode of approaching object sensing and a mode of ambient light sensing, and the microcontroller 23 transfers in turn the sensed signal to a microprocessor 24, and the microprocessor 24 may be further coupled with other components 25 and provide suitable data thereto. In particular, when the sensing device 20 is executing the function of approaching object sensing, the detector 22 detects the electromagnetic wave emitted by the emitter 21; while the emitter 21 may be temporarily turned off in advance, letting the detector detect other signals in addition to the electromagnetic wave generated by the emitter 21.

The detection workflow created by the aforementioned technologies may be shown in FIG. 3, which essentially expresses the operational method of two sensors within one sensing device, so as to sense a moving object and other light sources. Step S301 shows that electromagnetic wave of known waveband is emitted from an emitter in this sensing device; next, in step S303, under the mode of approaching object sensing, the detector detects the electromagnetic generated by the emitter; then, in step S305, it shows that it may sense other light sources under the mode of ambient light sensing.

Some prior arts use one or more sensors in one device to monitor various forms of electromagnetic waves. According to one more prior art such as U.S. Pat. No. 7,135,976 (issued on Nov. 14, 2006), a wireless monitor device has been provided to includes more than one sensors detect the various forms of energies including visible light, infrared light, magnetic fields, radio frequency energy and sound. U.S. Pat. No. 7,135,976 also discloses the monitor having a sleep mode for conserving power, a continuous mode for continuously monitoring, and a mode for periodically waking-up a microprocessor to take readings and perform other tasks.

### SUMMARY OF THE INVENTION

Distinguished from a sensing device having a sensor of different sensing functions provided by prior art, the objective of the present invention is to provide an electromagnetic sensing apparatus with two or more different electromagnetic sensing ranges, and the various operating modes are functioned to do the various applications.

According to one of the embodiments, in the method adapted to an electronic wave sensing apparatus with integration of multiple sensors, a host is enabled to configure one or more sensors of the electronic wave sensing apparatus. The setting hems in the configuration are such as resolution, gain, data rate, frequency, and driving current; the host is also enabled to set up a control unit, and the related setting items are such as output format, output gain, output source, output level, and output driving current. After that, when the host enables the control unit and one or more selected sensors according to one or more setting items.

Further, in response to the configuration made for the one or more sensors, the step in the method is to detect electromagnetic signals, transmit electronic signals converted from the electromagnetic signals to the control unit. Still further, in response to the setting made for the control unit, the step in the method is to adjust or convert the electronic signals to meet the setting. After the adjustment or conversion, the signals are accordingly outputted.

According to the selected setting items, the control unit drives one or more internal devices or external devices. For example, when the internal device is an internal emitter, in response to the control signal, the internal emitter is driven to emit detection signals which are received by the one or more sensors for performing proximity detection. When the external device is an external emitter, in response to the control signal, the external emitter is driven to emit detection signals which are received by the one or more sensors for adjusting luminance of a light source. When the detection signals are emitted by the external emitter and received by the one or more sensors, the electronic wave sensing apparatus is used for performing backlight adjustment.

In one further application, when the internal device is an internal emitter associated with the external device being an external emitter, in response to the control signal, the internal and external emitters respectively emit signals which are received by the one or more sensors, thereby a difference between the signals received by the one or more sensors is served to detect a moving object. Further, when a series of differences are detected within a period of time, the electronic wave sensing apparatus is functioned to detect a gesture.

In one further aspect of the present invention, the electromagnetic wave sensing apparatus with integration of multiple sensors includes a control unit, receiving instruction from a host via a transmission interface, a function selector, which is used to enable one or more functions associated to one or more sensors integrated in the electromagnetic wave sensing apparatus in response to control signal made by the control unit. The apparatus also includes one or more sensors which are configured by the host in response to one or more setting items selected from resolution, gain, data rate, frequency, and driving current. One or more internal devices are selectively enabled in response to control signal made by the control unit. Furthermore, a signal output circuit is included for receiving signals from the control unit to one or more internal devices or one or more external device.

In one embodiment, one of the sensors is a temperature sensor used to sense an ambient temperature inside the sensing apparatus in response to a corresponding enabled function. A signal transforming unit is selectively included in the apparatus, and used to transform the sensed signals into linear-to-linear or linear-to-log electrical signals. Furthermore, at least one electromagnetic wave filter may be used to filter the to-be-sensed electromagnetic wave into one or more specified ranges.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a diagram of a sensing device having a plurality of sensors in prior art;

FIG. 2 illustrates a diagram of an integrated sensing device in prior art;

FIG. 3 illustrates a detection flowchart in prior art;

FIG. 4 illustrates a schematic diagram of an embodiment of the electromagnetic wave sensing apparatus according to the present invention;

FIG. 5 depicts a frequency response chart of electromagnetic wave discernible by human eyes; and

FIG. 6 illustrates a circuit block diagram of a preferred embodiment of the electromagnetic wave sensing apparatus according to the present invention;

FIG. 7 shows a block diagram illustrating the preferred embodiment of the sensing apparatus in accordance with the present invention;

FIG. 8 shows a flow chart illustrating the process for configuring the sensing apparatus by a host in accordance with the present invention;

FIG. 9 shows a flow chart illustrating the process for outputting result of the sensing apparatus in accordance with the present invention;

FIG. 10 is another flow chart enabling the applications of the present invention.

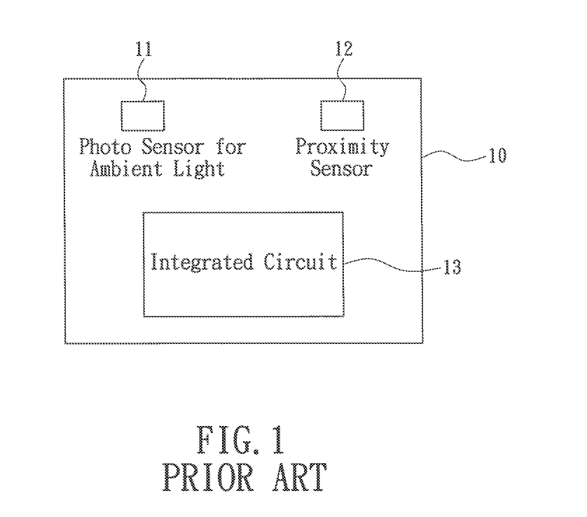

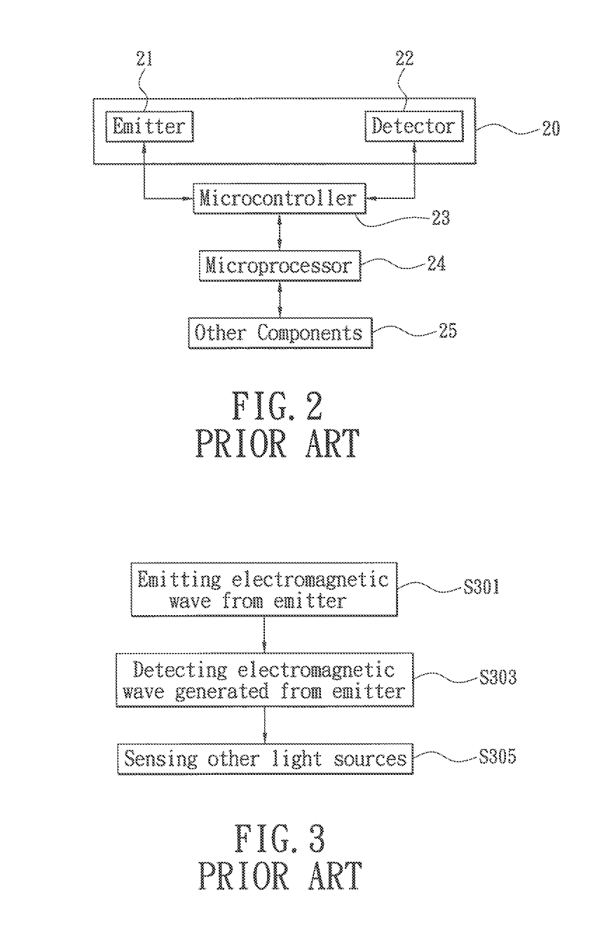

### DETAILED DESCRIPTION OF THE PREFERRED EMBODIMENTS

While the present invention will be described more fully hereinafter with reference to the accompanying drawings, in which a preferred embodiment(s) of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The electromagnetic wave sensing apparatus provided by the present invention can integrate multiple sensing units for sensing electromagnetic wave energy from environment or specific electromagnetic wave sources, and includes a circuit of post-sensing signal process, such as the analog-to-digital signal transforming circuit for transforming light signal into electrical signal, comprising setting the electromagnetic sensing ranges and parameters transferred therein, and even performing signal interrupt process between other processing units therewith. Through various setting, it is possible to enable the final output to have a specific feature, such that the companies using such a product do not need to employ different hardware or software algorithm according to different product supplied.

The electromagnetic wave sensing apparatus provided by the present invention is essentially to install a plurality of sensing units within a sensing apparatus, which includes at least two types of electromagnetic wave sensing apparatus for sensing different electromagnetic wave ranges, enabling to set the sensing ranges in the sensing units based on actual need. In a preferred embodiment, it may respectively sense ambient light and electromagnetic wave of specific wavelength range.

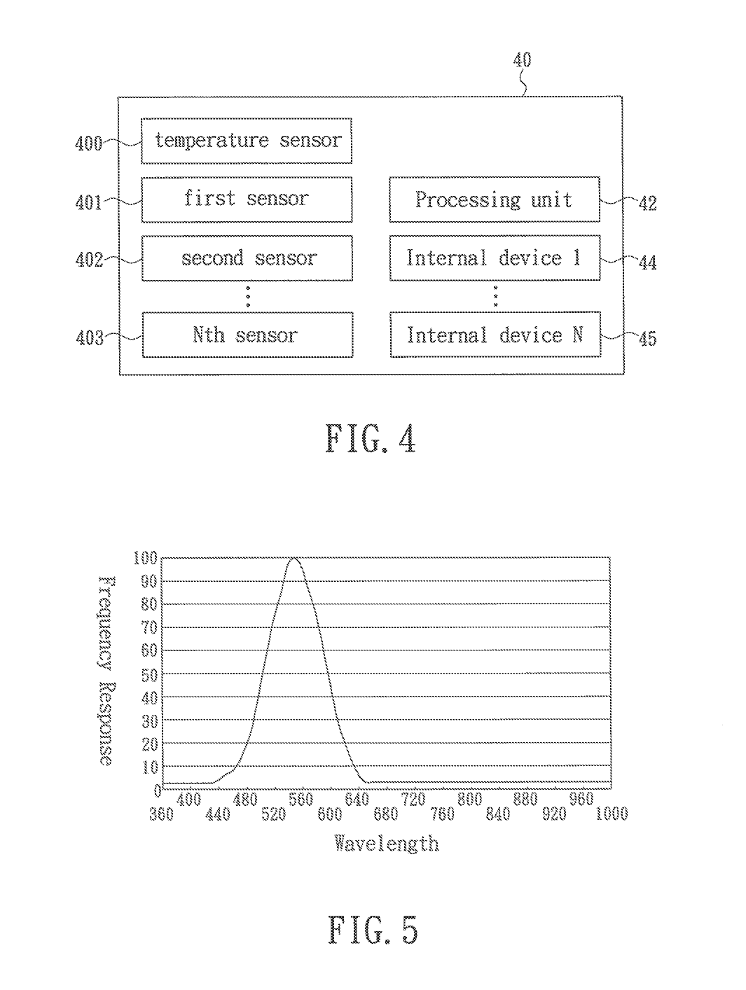

Referring to FIG. 4, a diagram of a preferred embodiment of the electromagnetic wave sensing apparatus with integration of multiple sensors according to the present invention is shown. The sensing apparatus 40 having multiple sensing units, for example such as the shown temperature sensor 400, first sensor 401, second sensor 402, and Nth sensor 403. In particular, in accordance with one embodiment, provided are two sensing units which may individually sense different ranges of electromagnetic wave, and both include at least a sensing component (not shown), such as photodiode, so as to respectively sense ambient light and electromagnetic wave within a specific range, and generate corresponding sensing signals.

For example, the electromagnetic wave within specific ranges sensed by the aforementioned first of second sensors (401, 402) may include visible and invisible light, and the included sensing components may be a plurality of diode components, e.g. photodiode, whose embodiment may be a diode component having a substrate with PN interfacing, metal layer, polymer layer or combination thereof stacked thereon. The sensing component in each sensing unit can alter its sensing waveband by modifying the process parameters, so as to decide the feature of the component and sensible range of electromagnetic wave during manufacture process.

The sensing apparatus 40 further includes a means of sensing signal post-process, which may be a sensing-signal processing unit 42, used to receive the sensing signal generated by the sensing component in each of the above-mentioned sensing unit. It may perform photo-electric signal transformation via a signal transforming unit for transforming light signal into electrical signal, and because that the light signal generated by receiving external electromagnetic wave is usually analogous, it will be hence converted again to digital electrical signal, including voltage or current signal, and the obtained result will be further output based on the working mode of the electromagnetic wave sensing apparatus.

Additionally, the means of sensing signal process can deal with electromagnetic wave with a specific wavelength from an external electromagnetic radiation source. The processing unit 42 controls the stop/start operation of the first sensor 401 or second sensor 402, as well as the operating time for each sensing unit, through parameters. It can especially set the specific sensing range of electromagnetic wave within the detecting range of each sensing unit, including visible light, invisible light, or limited to ambient light that human eye can distinguish.

Furthermore, the claimed sensing apparatus 40 also includes one or more built-in internal devices such as the shown internal device 1 (44), or even the internal device N (45). The internal devices (44, 45) are exemplarily controlled by the processing unit 42. For example, the internal device (44 or 45) may be an internal emitter which is used to emit detection signals for the application of performing proximity detection when the detection signals reflected by an object and the reflected signals are measured.

The electronic wave sensing apparatus 40 provides several working modes. One of the working modes is a full working mode. In the full working mode, it performs sensing operation any time, and sends interrupt request after the interrupt condition(s) is/are matched. Another working mode is a sleep mode, which means the sensing apparatus enters into an operation-halted condition. Additionally, one more working mode is such a semi-sleep mode, which initiates periodically the said electromagnetic wave sensing apparatus for sensing electromagnetic energy generated by the electromagnetic wave source in a periodic way, instead of performing sensing function constantly. This semi-sleep mode may allow reducing power consumption without stopping the work thereof.

Subsequently, the first sensor 401, second sensor 402, and the Nth sensor 403 in the above-mentioned electromagnetic wave sensing apparatus 40 may be separately associated with an electromagnetic wave filter (not shown). The one or more filters may filter an electromagnetic wave range to an electromagnetic wave range discernible by human eyes, such as, within the electromagnetic waveband of ranging from 450 nm to 650 nm, the maximum peak therein is about 550 nm. Referring to FIG. 5, wherein a frequency response chart of electromagnetic wave discernible by human eyes is shown.

Furthermore, the electromagnetic wave sensing apparatus 40 further includes a means of coupling, allowing to be coupled to other application devices, including electrically connected with a host through a transmission interface. One preferred embodiment is I²C serial transmission interface, thus the sensing signal therein can be transformed into a signal consistent with I²C serial transmission interface standard, and in turn electrically connected to the host via I²C serial transmission lines. Practical application may further include USB interface, IEEE1394 interface, RS-232, or other interfaces consistent with the specifications of various industrial standards.

In one embodiment, the electromagnetic wave sensing apparatus disclosed by the present invention further provides an ability of setting more than two interrupt points, and through the above-stated sensing-signal processing circuit which executes one or more interrupt conditions, with each interrupt point disperses in different energy range, when the energy of the electromagnetic wave matches one of the interrupt conditions, it can send an sensing signal to the host. Each interrupt point corresponds to different electromagnetic wave energy and signal intensity, indicating the electromagnetic wave sensing apparatus according to the present invention can generate multiple types of sensing signals, meet different needs and provide feature of customization.

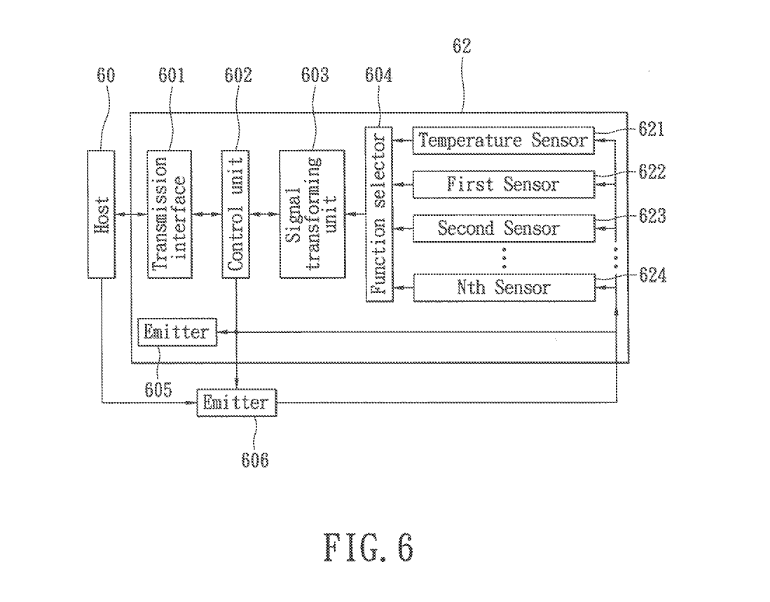

Another embodiment of the electromagnetic wave sensing apparatus according to the present invention combines a plurality of electromagnetic wave sensing units, forming thus an electromagnetic wave sensing apparatus capable of sensing a plurality of electromagnetic wave sources, as shown in the embodiment diagram of FIG. 6.

FIG. 6 illustrates a circuit block diagram of a preferred embodiment of the electromagnetic wave sensing apparatus according to the present invention.

In FIG. 6, a circuit block diagram of the sensing apparatus is disclosed. An electromagnetic wave sensing apparatus 62 is connected to a host 60 via a coupling means. The sensing apparatus 62 in this embodiment preferably includes a transmission interface 601 for communicating with the external circuit or device, such as to the host 60. The apparatus 62 includes a control unit 702 that is to be a processing kernel of the sensing apparatus 62 and is used to process the signals signaling among the units therein. The control unit 602 is electrically connected with the transmission interface 601 for transferring the sensing signals to the host 60. According to the present embodiment, this control unit 602 is served to configure the sensors exemplarily including the shown temperature sensor 621, and the various electromagnetic wave sensors 622, 623, and 624. In particular, the configuration to the sensors includes one or more setting items selected from resolution, gain, data rate, frequency, and driving current. The control unit 602 is particularly used to determine whether a certain interrupt condition is met in order to send the interrupt request to the host 60 and decide the timing to transfer the signals. The control unit 602 also controls the sensing modes mentioned above, such as the full working mode, sleep mode and semi-sleep mode.

A signal transforming unit 603 is electrically connected to the control unit 602. The signal transforming unit 603 is particularly used for performing a transformation that transforms the sensed signals into another state, for example transforms the sensed signals into linear-to-linear or linear-to-log electrical signals. After signal transformation, the signals are outputted according to the mentioned working mode configured.

Next, a function selector 604 is preferably included into this apparatus 62 in this embodiment. This function selector 604 is electrically connected with the signal transforming unit 603, and also the plurality of sensors such as the temperature sensor 621, a first sensor 622, a second sensor 623, and more to an Nth sensor 624. By a switching mechanism, those sensors 621 to 64 can be functioned by manual switching through the function selector 604, in which one or more sensors will be initiated based on the selection. More, two or more sensors can also be initiated simultaneously to create broader sensing range, and render various applications.

In an exemplary example such as shown in FIG. 6, the electromagnetic wave sensing apparatus 62 may be built in one emitter 605 that is used to emit the detection signal for some applications. For example, when the emitter 605 is driven, by the control unit 602, to emit detection signals towards any object outside the apparatus 62, the any enabled sensor (622, 623 or 624) is driven to sense the signals reflected from the object. The reflected signals allow to he measured for comparison with the or signals for acquiring the difference. The difference may be used to detect the distance to the object or even detect the movement of the object by acknowledging a series of differences. The internal emitter 605 can be disposed at one end of the apparatus 62, and associated with those sensors 621, 622, 623, and 624. Furthermore, the internal emitter 605 is designed for being configured by the claimed electromagnetic wave sensing apparatus 62. Users may directly set up the internal emitter 605 through the apparatus 62 by its own function.

Moreover, an external emitter 606 is shown as coupled to the apparatus 62. Preferably, the emitter 606 is disposed outside the apparatus 62, and being controlled through the host 60. The electromagnetic wave sensing apparatus 62 can use those electromagnetic wave sensors 622 to 624 as the receivers to sense one or more specific ranges of electromagnetic bands and generate one or more corresponding sensing signals. For example, the electromagnetic wave sensing apparatus 62 utilizes the emitter 605 to emit an infrared ray desired to detect a distance toward a remote object. Thus one of the sensors is configured to he a sensor able to sense the reflected infrared ray.

The external emitter 606 is, for example, implemented to have a photo-interrupter which employs the emitter 606 and a receiver (the sensors). In this exemplary example, the photo-interrupter is, but not limited to, used to measure a distance from an object by the change of signals since the light between the emitter and the receiver is interrupted by the object the interaction.

The electromagnetic wave sensing apparatus 62 particularly uses the temperature sensor 621 in this embodiment. Since the change of ambient temperature may affect die accuracy of the measurement by the apparatus 62, the temperature sensor 621 is used to measure the temperature around or inside the apparatus 62. The measured temperature becomes a basis for correcting the sensing signal. In the meantime, the value of measured temperature is transformed by the signal transforming unit 603 to electronic signal, which is especially to compensate the measurement by the apparatus 62. Since the outputted signals from the apparatus can be internally corrected by this compensation, the measurement can be more accurate.

More particularly, the present invention can set a plurality of interrupt points, which can be set through setting interface by external hosts. Additionally, it may further determine two types of interrupt modes, one is that interrupt occurs when the amplitude value exceeds a setting value, the other is that interrupt occurs when an accumulated value reaches a certain count.

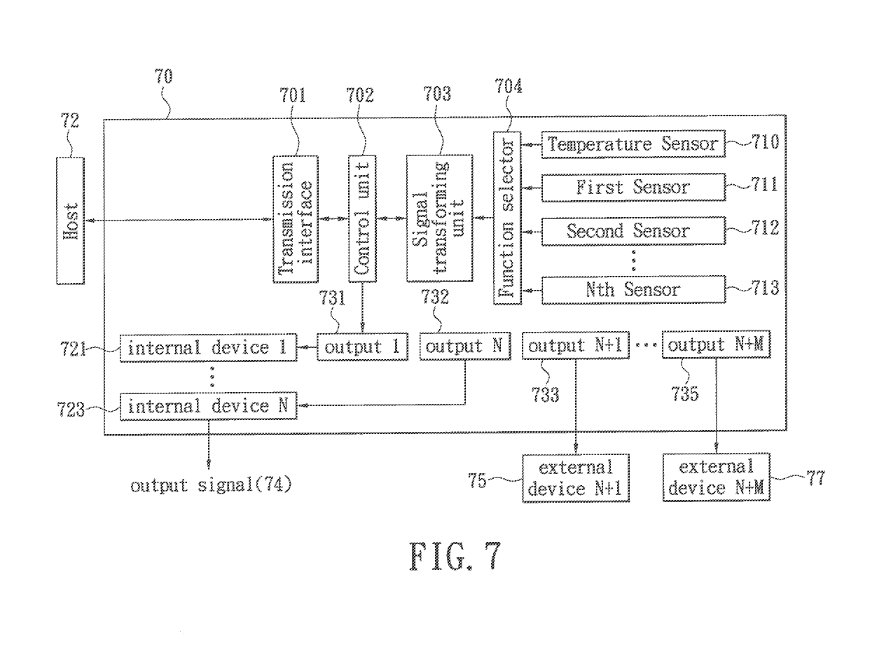

Reference is next made to FIG. 7 showing a block diagram illustrating the preferred embodiment of the sensing apparatus in accordance with the present invention;

The block diagram depicts the hardware or software-based functional blocks that embodies the electromagnetic wave sensing apparatus 70. A host 72 is served to configure the apparatus 70, including configuring the multiple sensors (710, 711, 712, 713) to meet the requirements for implementing the various applications. For example, based on the properties of the sensors, one or more setting items may be applied. The setting items may be selected from resolution, gain, data rate, frequency, and driving current. The host 72 is also provided to set up a control unit 702 of the apparatus 70. To the control unit 702 rather than the configuration to the sensors, one or more setting items may be selected from output format, output gain, output source, output level, and output driving current. Thus the host 72 allows enabling the control unit 702 or one or more selected sensors according to the one or more setting items.

In an exemplary embodiment, the control unit 702 receives instruction from the host 72 via a transmission interface 701. The transmission interface 701 is such as an I²C serial transmission interface, in which the sensed signals can be transformed into a signal consistent with I²C serial transmission interface standard. Some other types would be applied such as USB interface, IEEE1394 interface, RS-232, or other interfaces consistent with the specifications of various industrial standards.

A function selector 704 coupled to the control unit 702 is also provided. The function selector 704 is used to enable one or more functions associated to one or more sensors (710, 711, 712, 713) integrated in the electromagnetic wave sensing apparatus 70 in response to control signal made by the control unit 702. For example, the function selector 704 is such as a multiplexer (MUX) that is a device, in response to analog or digital signal made by the control unit 702, allowing selecting one or more sensors (710, 711, 712, 713) for achieving any purpose. Exemplarily, the function selector 704 may include several select lines coupled to the control unit 702.

The diagram shows several sensors such as temperature sensor 710, first sensor 711, second sensor 712, and to Nth sensor 713. The sensors (710, 711, 712, 713) are coupled to the function selector 704 and configured by the host 72 over the mentioned transmission interface 701. In response to one or more setting items selected from resolution, gain, data rate, frequency, and driving current, the one or more selected sensors (710, 711, 712, 713) are used to sense electromagnetic wave within one or more specified ranges according to one or more enabled functions. These sensors (710, 711, 712, 713) are particularly associated with the internal device(s) or/and external device(s).

The internal device 1 (721) through internal device N (723) are indicative of a plurality of internal devices being built in the sensing apparatus 70. These internal devices (721, 723) are coupled to the control unit 702 and selectively enabled in response to control signal respectively as the output 1 (731) or output N (732) made by the control unit 702. For example, when the internal device (721) is an electromagnetic wave emitter that emits the detection signal to an object, one of the sensors (710, 711, 712, 713) is enabled to sense a reflected wave from the object. That means the distance to the object may be obtained through the comparison of the emitted signals and the reflected signals. In an exemplary embodiment, for implementing proximity detection, the control unit 702 includes a comparator (or circuits) used to acquire a difference as comparing the reflected wave with the detection wave.

The figure also shows the sensing apparatus 70 includes some outputs N=1, . . . , N+M (733, . . . , 745) coupled to some external devices N+1, . . . , N+M (75, 77) correspondingly. In this embodiment, the claimed electromagnetic wave sensing apparatus 70 with integration of multiple sensors can be operated as a moving object detector. The one or more external devices may be as an external emitter associated to the internal device. The internal device (for example the internal electromagnetic wave emitter) and the external emitter are respectively emitting the signals which are reflected by any other object and received by the one or more sensors. Therefore, the comparator in the control unit 702 is used to obtain one or more differences by comparing the signals separately received by the one or more sensors. The difference(s) between the sensed signals is served to detect and determine any moving object.

Also, according to control signal issued by the control unit 702, one of the sensors (710, 711, 712, 713) can be selected. For example, one of the sensors (710, 711, 712, 713) may be made to be a temperature sensor 710, coupled to the function selector 704, that is used to sense an ambient temperature inside the sensing apparatus 70 in response to a corresponding enabled function. It is noted that the output of the temperature sensor 710 is defined based on the configuration to the sensors made by the host 72 in the initial stage.

Further, a signal transforming unit 703 may be included in the sensing apparatus 70 for some purposes. The signal transforming unit 703 is electrically connected with the control unit 702, and used to transform the sensed signals into linear-to-linear or linear-to-log electrical signals. Still further, one or more electromagnetic wave filters may be provided to the sensors for conducting the filtering electromagnetic wave. When the host 72 configures the sensors in the earlier stage, the filters are accordingly configured to filter the to-be-sensed electromagnetic wave into one or more specified ranges.

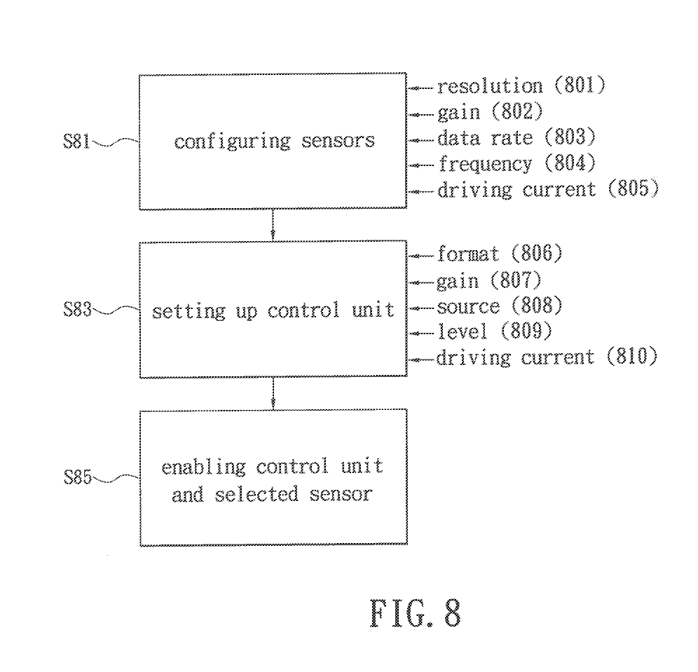

FIG. 8 shows a flow chart illustrating the process for configuring the sensing apparatus by a host in accordance with the present invention.

In step S81, the claimed electronic wave sensing apparatus with integration of multiple sensors is initialized. Provided further is to configure the sensors within the electronic wave sensing apparatus. The host coupled to this sensing apparatus is enabled to configure one or more sensors of the electronic wave sensing apparatus. The content of configuration includes one or more setting items selected from resolution (801), gain (802), data rate (803), frequency (804), and driving current (805) responsive to the property of the sensors.

Next, in step S83, the host then is enabled to set up the control unit. For meeting any requirement to the claimed sensing apparatus, the control unit should be configured to achieve the goal. The configuration to the control unit includes one or more setting items selected from output format (806), output gain (807), output source (808), output level (809), and output driving current (810). Accordingly, when the control unit is configured to set up the output to the internal device(s) or external device(s), the output format (806), the output gain (807), the output source (808), the output level (809) or/and the output driving current (810) will be constrained for the specified requirement.

Further, in step S85, after completing the configuration made to the sensors and the setting to the control unit, the host enables the control unit and one or more selected sensors according to one or more setting items correspondingly to configure the one or more sensors, and to set up the control unit. Therefore, the electronic wave sensing apparatus with integration of multiple sensors is ready for implementing a specific function.

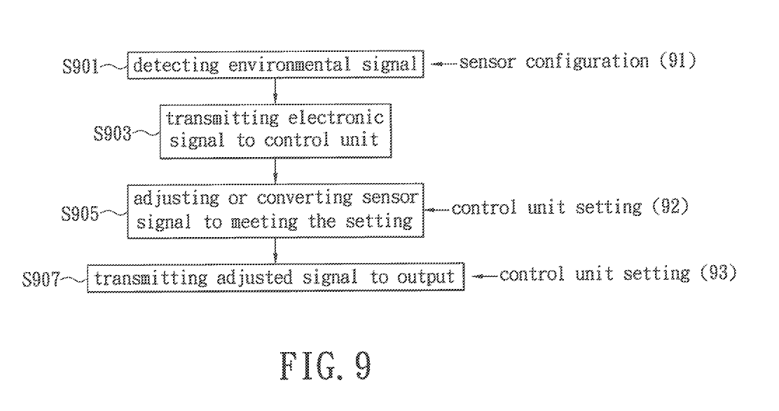

Reference is next made to FIG. 9. A flow chart shown in FIG. 9 is to illustrate the process for outputting result of the sensing apparatus in accordance with the present invention.

Based on the mentioned configurations to the sensors or/and the control unit, the electronic wave sensing apparatus with integration of multiple sensors is enabled. Such as in step S901, the one or more sensors are configured to detect the environmental signal according to the sensor configuration (91). Next, in step S903, when the apparatus receives the environmental signal, the sensor or the related circuit converts the electromagnetic signals into the electronic signals, and the electronic signals are transmitted to the control unit.

In step S905, in response to the setting made for the control unit (92), the electronic signals will he adjusted or converted to meet the setting. In step S907, in response to the setting to the control unit, the control unit is configured to send the control signal for instructing the related circuits to output the signals after adjustment or conversion.

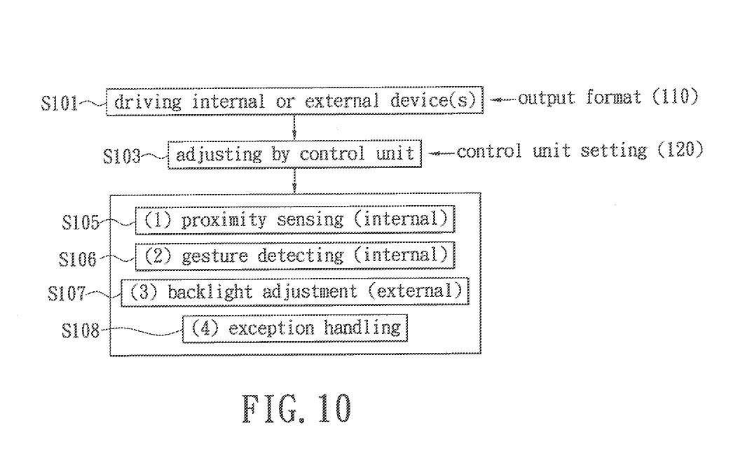

Some applications are introduced since the claimed electronic wave sensing apparatus is ready. Reference is made to FIG. 10.

While the output format (110) is defined, the one or more internal or external devices are driven by the control unit when the control unit generates a control signal to conduct the driving. The control unit setting (120) is applied onto the control unit for performing adjustment, especially to adjust the output in accordance with the one or more setting items selected from output format, output gain, output source, output level, and output driving current.

When the host enables the control unit and one or more selected sensors according to the mentioned one or more setting items, the claimed sensing apparatus is initiated to process some applications. Such as the step S105, it shows a proximity sensing function. In which, when the internal device is an internal emitter, in response to the control signal, for emitting detection signals, the detection signals are then received by the one or more sensors for performing proximity detection.

Step S106 shows the function of gesture detection. When the detection signals are transmitted h the internal emitter(s), a series of differences between the transmitted and received signals may be acquired within a period of time, the differences within the period of time can be used to detect a gesture.

Step S107 indicates a function of backlight adjustment. When the external device is made to be an external emitter, the detection signals emitted by the external emitter will be received by the one or more sensors. The sensed signals will he referred to perform backlight adjustment.

Some further applications may not be excluded based on the aspect of the invention (step S108).

In summary, the electromagnetic wave sensing apparatus disclosed by the present invention is a sensing apparatus which integrates two or more sensing units, signal transforming/control units, transmission interface, internal or external devices, enabling the integration of calculation, transformation and parameter setting of sensing signals into one apparatus, such that the product according to the present invention can generate consistent feature.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method, adapted to an electronic wave sensing apparatus with integration of multiple sensors, comprising:
a host enabled to configure one or more sensors of the electronic wave sensing apparatus with integration of multiple sensors, including one or more setting items selected from resolution, gain, data rate, frequency, and driving current;
the host enabled to set up a control unit electrically connected with the multiple sensors, including one or more setting items selected from output format, output gain, output source, output level, and output driving current;
the host enabling the control unit and one or more selected sensors according to one or more setting items correspondingly to configure the one or more sensors, and to set up the control unit;
in response to the configuration made for the one or more sensors, detecting electromagnetic signals;
transmitting electronic signals converted from the electromagnetic signals to the control unit;
in response to the setting made fix the control unit, adjusting or converting the electronic signals to meet the setting; and
outputting the signals after adjustment or conversion.

2. The method according to claim 1, wherein, in response to the one or more setting items selected from the output format, output gain, output source, output level, and output driving current, the control unit drives one or more internal devices or external devices.

3. The method according to claim 2, wherein the internal or external device is controlled by the control unit when the control unit generates a control signal while the internal or external device is driven.

4. The method according to claim 3, wherein the internal device is an internal emitter, in response to the control signal, for emitting detection signals which are received by the one or more sensors for performing proximity detection.

5. The method according to claim 3, wherein the external device is an external emitter, in response to the control signal, for emitting detection signals which are received by the one or more sensors for adjusting luminance of a light source.

6. The method according to claim 5, wherein the detection signals emitted by the external emitter and received by the one or more sensors for performing backlight adjustment.

7. The method according to claim 3, wherein the internal device is an internal emitter associated with the external device being an external emitter, in response to the control signal, respectively emitting signals which are received by the one or more sensors, thereby a difference between the signals received by the one or more sensors is served to detect a moving object.

8. The method according to claim 7, wherein a series of differences detected within a period of time is used to detect a gesture.

9. An electromagnetic wave sensing apparatus with integration of multiple sensors, comprising:
a control unit, receiving instruction from a host via a transmission interface in the electromagnetic wave sensing apparatus and set up by the host in response to one or more setting items selected from output format, output gain, output source, output level, and output driving current;
a function selector, coupled to the control unit, used to enable one or more functions associated to one or more sensors integrated in the electromagnetic wave sensing apparatus in response to control signal made by the control unit;
one or more sensors, coupled to the function selector and configured by the host in response to one or more setting items selected from resolution, gain, data rate, frequency, and driving current, used to sense electromagnetic wave within one or more specified ranges according to one or more enabled functions;
one or more internal devices, coupled to the control unit and selectively enabled in response to control signal made by the control unit; and
signal output circuit, for receiving signals from the control unit to one or more internal devices or one or more external device, including receiving control signal to enable the one or more internal or external devices.

10. The apparatus of claim 9, wherein the internal device is an electromagnetic wave emitter.

11. The apparatus of claim 10, wherein one of the sensors is to sense a reflected wave from an object while the emitter emits detection wave to the object.

12. The apparatus of claim 11, wherein the control unit includes a comparator used to acquire a difference as comparing the reflected wave with the detection wave for implementing proximity detection.

13. The apparatus of claim 10, wherein the electromagnetic wave emitter is associated with the external device being an external emitter, respectively emitting signals Which are received by the one or more sensors.

14. The apparatus of claim 14, wherein the control unit includes a comparator used to obtain one or more differences by comparing the signals separately received by the one or more sensors for implementing moving object detection.

15. The apparatus of claim 9, wherein one of the sensors is a temperature sensor, coupled to the function selector, used to sense an ambient temperature inside the sensing apparatus in response to a corresponding enabled function.

16. The apparatus of claim 9, further comprising a signal transforming unit, which is electrically connected with the control unit, used to transform the sensed signals into linear-to-linear or linear-to-log electrical signals.

17. The apparatus of claim 9, further comprising at least one electromagnetic wave filter electrically to the one or more sensors and used to filter the to-be-sensed electromagnetic wave into one or more specified ranges.
